(19) United States
(12) Patent Application Publication
(10) Pub. No.: US 2025/0196075 A1
(43) Pub. Date: Jun. 19, 2025

(54) DEVICES AND METHODS FOR MIXING GASES

(71) Applicant: Wacker Chemie AG, Munich (DE)

(72) Inventors: Buechner Alexander, Munich (DE); Bernhard Eckl, Munich (DE); Christian Hohmann, Munich (DE); Andreas Mueller, Munich (DE); Heribert Westermayer, Munich (DE)

(73) Assignee: Wacker Chemie AG, Munich (DE)

(21) Appl. No.: 18/842,835

(22) PCT Filed: Apr. 27, 2022
(86) PCT No.: PCT/EP2022/061215

§ 371 Date: Aug. 30, 2024

(51) Int. Cl. B01F 25/313; B01F 23/10

(52) U.S. Cl. CPC B01F 25/31331; B01F 23/10; B01F 25/31322; B01F 2215/044

(57) ABSTRACT

Devices made of stainless steel for mixing gases and methods for mixing gases. Where the device includes a main pipe into which a plurality of plates are inserted and arranged parallel to one another and extend from one pipe wall to the opposite pipe wall of the main pipe. A distributor pipe from which a plurality of supply lines branch off outside the main pipe. Where each supply line leads into a separate plate of the plates and is connected in the plates to a plurality of channels that are connected via outlet openings to the main pipe. Where the outlet openings are installed at the end faces of the plates facing away from the gas flow when a gas flows through the main pipe and where the end faces of the plates facing away from the gas flow when a gas flows through the main pipe are flat.

The invention relates to devices and methods for mixing gases, in particular for mixing reactive gases, for example for mixing oxygen with gaseous hydrocarbons.

When mixing gases, the aim is to achieve homogeneous gas mixtures in the most efficient way possible. For example, the homogeneous mixtures should be obtained within a short mixing length and/or within a small mixing volume. This is particularly relevant when mixing reactive gases such as oxygen-containing gas or even pure oxygen with, for example, hydrocarbon-containing gas, since this can result in the formation of ignitable gas volumes, for example with ethylene when the oxygen content is ≥8% by volume, which is problematic from a safety viewpoint. Even when producing gas mixtures that have an oxygen content below the ignitable gas volume, the ignitable range is unavoidably entered when pure or highly concentrated oxygen is introduced into, for example, a hydrocarbon-containing gas during mixing, since local oxygen concentrations above the ignition threshold arise in the mixing region. Ignition occurs when an ignition source is present in addition to the ignitable gas volume. Ignition sources must therefore be eliminated when handling ignitable gas volumes. An ignition source with sufficient ignition energy can for example be nothing more than a particle that is carried along in the gas stream and hits a pipe wall with appropriate impulse.

In conventional processes, oxygen or oxygen-containing gas is commonly injected at the edge in point form or distributed over the circumference of the main flow of the hydrocarbon gas stream. However, in such practices the formation of ignitable gas volumes is acute. To address this problem, EP1726355A2 and WO2009078899A1, for example, suggest supplying the oxygen via a nozzle, in particular via a nozzle head. A disadvantage of such an approach is that it requires a relatively large mixing volume with a relatively long mixing zone in order to achieve an adequately homogeneous mixture. In U.S. Pat. No. 4,573,803A, a corrosive fluid is injected into a pipe via nozzles. U.S. Pat. No. 3,706,534A and WO2009102311A2 strive for a distribution across the cross section of the main flow, but a deflection of the main flow is present that results in a high pressure loss. Moreover, a rectification of the flow is achievable here only by a large mixing length. Rectification of the main flow alongside distribution over the cross section is achieved in DE3037817A1 by injecting the oxygen perpendicular to the flow direction. However, this generates an ignitable volume in the region of potential particle collision surfaces. All in all, mixing processes up to now have been associated with a large mixing length or a large mixing volume and the mixing of reactive gases with exclusion of particles potentially carried along in the gas as ignition sources has yet to be satisfactorily resolved.

Against this background, there was in addition the object of providing devices and methods for mixing gases, in particular for mixing reactive gases, such as oxygen or an oxygen-containing gas with gaseous hydrocarbons, while mitigating one or more of the problems discussed above. Mixing here should preferably be carried out in an efficient manner; for example, it should be possible to obtain adequately homogeneous mixtures when mixing with a short mixing length or a small mixing volume. Preferably, when mixing reactive gases, the formation of ignitable gas volumes should also as far as possible be excluded or at least kept as low as possible, that is to say kept as brief as possible in time and/or space, thus making the mixing of reactive gases as safe as possible. Preferably, the release of ignition energy, particularly in the region of any ignitable gas volumes, should be reduced or preferably excluded.

The invention provides devices for mixing gases, comprising
a main pipe 1 into which are inserted a plurality of plates 2 arranged parallel to one another, these plates extending from one pipe wall to the opposite pipe wall of the main pipe 1 and oriented with their flat sides 3 parallel to the longitudinal direction of the main pipe 1, and
a distributor pipe 4 from which a plurality of supply lines 4a branch off outside the main pipe 1,
wherein each supply line 4a leads into a separate plate 2 and is connected in the plate 2 to a plurality of channels 5 that are connected via outlet openings 6 to the main pipe 1,
wherein the outlet openings 6 are installed at the end faces of the plates 2 facing away from the gas flow when a gas flows through the main pipe 1.

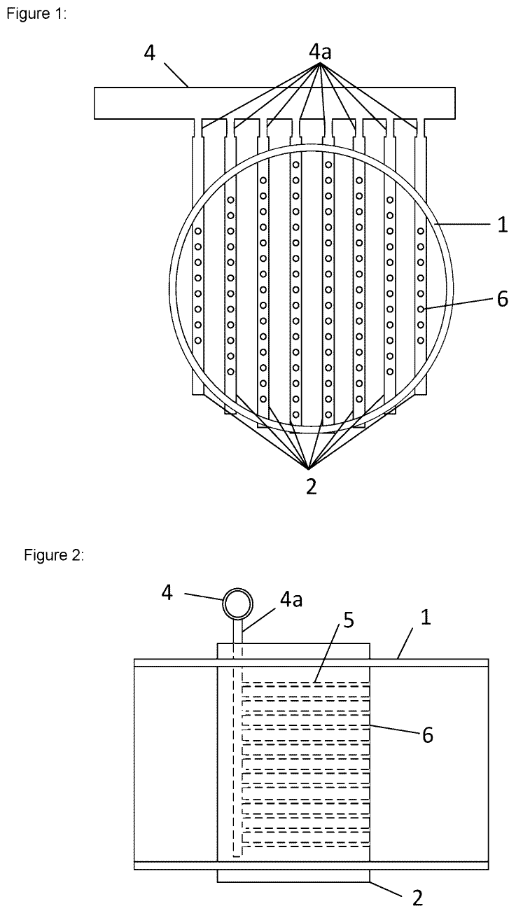

Such a device is illustrated by way of example in FIGS. 1 to 3 with further preferred configurations.

FIG. 1 shows a cross section through the main pipe 1 with top view of the end face of the plates 2 and the outlet openings 6 of the plates 2 and with top view of the distributor pipe 4 and the supply lines 4a.

FIG. 2 is a longitudinal section through the main pipe 1 with a cross section through the end face of a plate 2 and the channels 5 and outlet openings 6 of this plate 2 and a cross section through the distributor pipe 4 and a supply line 4a.

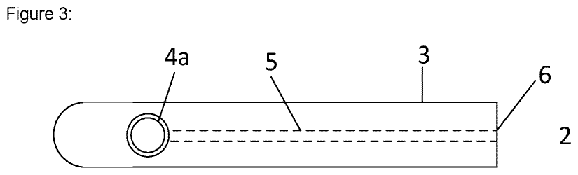

FIG. 3 is a cross section through a plate 2, a supply line 4a, and an outlet opening 6, and a longitudinal section through a channel 5 of this plate 2.

The invention also provides methods for mixing gases in which, in the device according to the invention,
a first gas is passed through the main pipe 1 and
a second gas is introduced into the distributor pipe 4 and is conveyed via the supply lines 4a and the channels 5 through the plates 2 and flows into the main pipe 1 via a plurality of outlet openings 6.

The plates 2 are preferably cuboidal with two longer sides, preferably sides of different lengths, and a shorter side. The two flat sides 3 of a plate 2 are generally the two largest surfaces thereof. The flat sides 3 of the plates 2 are generally aligned parallel to the longitudinal direction of the main pipe 1, preferably parallel to the flow direction of the first gas through the main pipe 1.

Two opposite end faces of the plates 2 are generally aligned perpendicular to the longitudinal direction of the main pipe 1, preferably perpendicular to the flow direction of the first gas through the main pipe 1. The wide side or in particular the long side of the plate 2 is preferably oriented transverse to the longitudinal direction of the main pipe 1. The long side or in particular the wide side of the plate 2 is preferably aligned in the direction of the pipe wall of the main pipe 1.

The plates 2, in particular the wide sides of the plates 2, may be fixed for example to the pipe walls of the main pipe 1. Preferably, the plates 2, in particular the wide sides of the plates 2, penetrate through the pipe walls of the main pipe 1. The points of contact of the plates 2 and of the main pipe 1 are generally sealed gas-tight. The plates 2 and the main pipe 1 may be connected to each other for example by a weld. The plates 2 are generally firmly inserted into the main pipe 1.

The end faces of the plates 2 located in the main pipe 1 or the segments of the end faces of the plates 2 located in the main pipe 1 may be any shape, but are preferably flat or rounded. Preferably, the end faces of the plates 2 facing the gas flow when a gas, in particular the first gas, flows through the main pipe 1, or when a gas is flowing onto them, are rounded. Preferably, the end faces of the plates 2 facing away from the gas flow when a gas, in particular the first gas, flows through the main pipe 1, or when a gas is not flowing onto them, are flat or angular.

Preferably, ≥2, more preferably ≥4, and most preferably ≥6, plates 2 that are arranged parallel to one another in accordance with the invention are inserted into the main pipe 1.

In a cross section through the main pipe 1 and the plates 2, the total cross-sectional area of the plates 2 arranged parallel to one another is preferably 20% to 60%, more preferably 30% to 50%, of the cross-sectional area of the main pipe 1. The cross-sectional area of the main pipe 1 generally refers here to the inner diameter of the preferably round main pipe 1.

The thickness of the plates 2 is in principle variable and can be interpreted by those skilled in the art in the usual way and is guided by, for example, the diameter of the channels 5, standard safety requirements when working with gases under the pressure in the particular case, and the desired mechanical stability of the plates 2 in the individual case.

The thickness of the plates 2 is preferably 3 to 10 cm.

The distance between two adjacent parallel plates 2 is preferably 5 to 15 cm.

Through the preferred configurations and the number of plates 2, it is possible, for example, for the pressure loss of gases when flowing through the main pipe 1 and through the device according to the invention to be reduced and for a rectification of the main flow in the region of the device according to the invention to be achieved.

The channels 5 of a plate 2 branch off preferably perpendicularly from the supply line 4a.

The gas flowing out of the outlet openings 6 of the plates 2, also referred to as the second gas, has preferably the same flow direction as the gas flowing through the main pipe 1, also referred to as the first gas.

The outlet openings 6 of one or more, preferably all, of the plates 2 are preferably installed perpendicular to the cross section of the main pipe 1. All outlet openings 6 of all plates 2 arranged parallel to one another in accordance with the invention are preferably arranged such that all outlet openings 6 are in a plane perpendicular to the cross section of the main pipe 1. This too is able to counter the formation of ignitable volumes in the regions in which particles can collide with, for example, a pipe wall or internals; this means that the release of ignition energy in the region of any ignitable gas volumes can be reduced or excluded, for example, with this configuration of the device too.

An alignment of the outlet openings 6 in the flow direction of the gas in the main pipe 1 contributes for example to preventing any particles present in the main pipe 1 or carried along by the gas in the main pipe 1 from colliding with the pipe wall of the main pipe 1 as a result of turbulent mixing with the gas flowing out of the outlet openings 6, and thus counters a possible ignition process. The preferred plates 2 with flat or rounded end faces also help achieve this.

Preferably, the outlet openings 6 and the channels 5 of the plates 2 are designed such that the pressure loss of the gas flow through the channels 5 prevents a backflow of gas from the main pipe 1 into the channels 5.

The diameter of the outlet openings 6 is preferably ≥1 mm, more preferably 2 to 5 mm, and most preferably 2.5 to 4.5 mm.

The diameter of the channels 5 is preferably ≥1 mm, more preferably 2 to 5 mm, and most preferably 2.5 to 4.5 mm.

The length of the channels 5 corresponds preferably to ≥50%, more preferably ≥60%, and most preferably ⅔, of the length, in particular the width, of the plates. The length of the channels 5 is preferably ≤95%, more preferably ≤85%, and most preferably ≤75%, of the length, in particular the width, of the plates. The channels 5 have a length of preferably at least 5 cm, more preferably at least 10 cm.

The number of outlet openings 6 is preferably ≥100, more preferably ≥300, and most preferably ≥700, based on a 1 m² cross-sectional area of the main pipe 1. This cross-sectional area is generally determined at the point of the main pipe 1 at which the outlet openings 6 are present. The cross-sectional area of the main pipe 1 generally refers here to the inner diameter of the preferably round main pipe 1.

The outlet openings 6 are preferably uniformly distributed over the entire cross section of the main pipe 1, with the proviso that the distances of the outlet openings 6 from the inner wall of the main pipe 1 are preferably greater than the distance between two adjacent outlet openings 6 of a plate 2. The outlet openings 6 of each plate 2 are preferably uniformly distributed on one end face of the plate 2 with preferably a greater distance to the inner wall of the main pipe 1. These configurations too can contribute to the different gases being mixed with one another more efficiently.

The outlet openings 6 of a plate that are closest to the inner wall of the main pipe 1 are a distance from the inner wall of the main pipe 1 that is preferably 3% to 15%, more preferably 5% to 10%, of the diameter of the main pipe 1. This is advantageous in order to counter the formation on the inner wall of the main pipe 1 of ignitable mixtures of the gases undergoing mixing.

The outlet openings 6 are preferably deburred.

The total cross-sectional area of all channels 5 is preferably less than 60%, more preferably less than 40%, of the cross-sectional area of the supply line 4a. The total cross-sectional area of all supply lines 4a is preferably less than 66%, more preferably less than 40%, of the cross-sectional area of the distributor pipe 4. The pressure loss of the gas when flowing through the channels 5 is preferably greater than the total pressure loss of this gas when flowing through the distributor pipe 4 and the supply line 4a. Preferably, the pressure loss of the gas when flowing through the channels 5 is ≥50%, more preferably ≥70%, based on the total pressure loss of the gas when flowing through the distributor pipe 4, the supply line 4a, and the channels 5. With these preferred embodiments too, the efficiency of mixing of the gases can be improved.

Preferably, at least 2, more preferably at least 4, and particularly preferably at least 6, supply lines 4a branch off from the distributor pipe 4. Most preferably, the same number of supply lines 4a branches off from the distributor pipe 4 as there are plates according to the invention inserted parallel to one another in the main pipe 1.

Preferably, each supply line 4a tapers at the point at which the supply line 4a branches off from the distributor pipe 4.

Each supply line 4a within the plates 2 runs preferably parallel to the wide side, more preferably parallel to the long side, of the plate 2. The supply lines 4a are preferably oriented transversely to the longitudinal direction of the main pipe 1.

In a preferred embodiment, the supply lines 4a do not pass through the plates 2 completely. In this embodiment, the supply lines 4a end in the respective plate 2. In an alternative preferred embodiment, one or more or all supply lines 4a extend from one end of the plate 2 as far as the other end of the plate 2. This embodiment is preferable in order to attach, for example, a pressure measuring device to the end of the supply line 4a facing away from the distributor pipe 4.

The velocity of the second gas on exiting the outlet openings 6 is preferably greater than the velocity of the first gas in the segment of the main pipeline 1 at which the plates 2 are located. The velocity of the second gas on exiting the outlet openings 6 is preferably twice as high, more preferably three times as high, as the velocity of the first gas in the main pipeline 1 spatially upstream of the plates 2, in particular spatially directly upstream of the plates 2.

Preferably, there are no control devices installed on the channels 5 and/or the outlet openings 6 of the plates 2, for example no control unit for controlling the pressure or the flow velocity of the gas. Such parameters are preferably set via the supply of the gas into the distributor pipe 4.

The main pipe 1 is in the region, in particular at the point, at which the plates 2 are inserted into the main pipe 1, preferably linearly or in a straight line. Particularly preferably, the main pipe 1 here has no bend, does not taper or does not widen. The main pipe 1 is preferably linear or in a straight line.

With the preferred configurations and process parameters with respect to the distributor pipe 4, the supply lines 4a, channels 5, plates 2, and outlet openings 6, it is for example possible to counter a backflow of gas in channels 5. This too is able to improve the safe operation of the device of the invention.

The device according to the invention may for example be an integral component of a pipe or a plant unit or preferably be fitted in a pipeline via flanges.

The device according to the invention may be made of the usual materials that are commonplace in plant engineering for the respective gases and applications, for example stainless steel.

The first gas and the second gas are preferably reactive with each other. The first gas and the second gas may in both cases be pure gases or gas mixtures.

The first gas is introduced into the main pipe 1. The first gas is preferably a flammable gas. The first gas contains preferably one or more hydrocarbons, more preferably ≥50% by volume and most preferably ≥95% by volume of hydrocarbons, based on the total volume of the first gas. The first gas is preferably free of non-gaseous constituents.

The second gas is introduced into the distributor pipe 4. The second gas preferably contains oxygen, more preferably ≥20% by volume and most preferably ≥95% by volume of oxygen, based on the total volume of the second gas. Purely for the sake of clarity, it should be noted that the device is not limited to the injection of pure oxygen or oxygen-containing mixtures.

The gas flowing through the distributor pipe 4 has a pressure that is preferably greater than the pressure of the gas or gas mixture in the vicinity of the outlet openings 6. The actual pressure can be adjusted by those skilled in the art in the usual manner according to the requirements in the individual case and the device accordingly designed in a conventional manner per se.

Preferably, the gases to be mixed have the same temperature. The actual temperature depends on the requirements in the individual case. In principle, the device can be operated at the temperature or temperature range required in the respective process. A temperature sufficiently far apart from the ignition temperature is preferable. The temperatures customary from the viewpoint of those skilled in the art may be chosen; the temperatures of the gases are preferably above the respective dew points of the gases to be mixed. The dew points can be taken from standard works, for example Poling, Bruce E., John M. Prausnitz, and John P. O'Connell, “The properties of gases and liquids”, vol. 5, New York: McGraw-Hill, 2001, ISBN: 978-0071189712.

In principle, the gas mixture produced according to the invention may contain any desired proportions of the first and second gas. The gas mixture produced according to the invention preferably contains 1% to 99% by volume, more preferably 3% to 30% by volume, and most preferably 5% to 15% by volume, of oxygen, based on the total volume of the gas mixture. The gas mixture produced according to the invention preferably contains 1% to 99% by volume, more preferably 20% to 80% by volume, and most preferably 50% to 70% by volume, of hydrocarbons, based on the total volume of the gas mixture. The composition of the gas mixture produced according to the invention is preferably at least 20%, more preferably at least 15%, and most preferably at least 10%, below the lower ignition threshold of the gas mixture produced according to the invention. The lower ignition threshold can be taken from standard works and is also for example determined by the German Federal Office for Materials Research and Testing.

The devices according to the invention and the methods according to the invention are particularly suitable for metering oxygen into hydrocarbon gas streams. This is required in many industrial-scale processes, for example in the production of vinyl acetate or ethylene oxide.

The device according to the invention and the method according to the invention permit a homogeneous and efficient mixing of gases that is advantageously manifested for example in a short mixing length, a small mixing volume or a mixing zone that is short in length and thus, by association, a short mixing time.

The procedure of the invention is particularly advantageous for mixing reactive gases, in particular for mixing oxygen or oxygen-containing gases with hydrocarbon-containing gases, since the inherently latent risk here with regard to ignitable gas volumes and ignition sources can be dramatically mitigated. Thus, through minimizing the mixing volume in accordance with the invention, it is also possible to minimize a possible ignitable volume. In addition, the introduction according to the invention of a gas via the distributor pipe 4, the supply line 4a, the channels 5, and the plates 2, means that any particles that are often carried along or entrained in gas flows do not become ignition sources, since their collision with a pipe wall or internals with the release of ignition energy in the region of ignitable gas volumes can at the very least be reduced or even excluded altogether.

All in all, the mixing process according to the invention makes it possible to achieve an advantageous rectification of the various gas flows that contributes to the advantageous effects according to the invention.

In addition, the outlet openings 6 are installed on the side of the plates 2 facing away from the flow, which means that collision surfaces for particles are unable to occur in the region of the mixing volume and the individual mixing regions that result downstream of the plates 2 are located in the flow shadow of these plates 2. Since the individual mixing regions are not contiguous, ignition of one of the mixing regions will not normally also ignite all the other mixing regions. This further reduces the safety risk and further reduces the consequences for the device and its environment.

In the method according to the invention, the inventive design of the device according to the invention advantageously allows pressure losses of the gas flow in the main pipe 1 to be kept low. In particular, it is possible to dispense with the deflection or constriction of the main flow that is typical in conventional mixing devices but leads to pressure losses.

All of these advantages culminate in a very fast, efficient, homogeneous mixing of gas flows allied with safe operation of the device and this with comparatively low pressure losses and without loss of capacity.

The following examples serve to elucidate the invention in more detail and are not to be understood as being limiting in any way.

### Hydrocarbon-Containing Stream A:

The hydrocarbon-containing stream A consisted of 60% by volume of ethene, 15% by volume of CO₂, 15% by volume of acetic acid, and 10% by volume of inert gases and had a mass flow of 40 kg/s.

### Oxygen-Containing Stream B:

The oxygen-containing stream B consisted of 99.5% by volume of oxygen and 0.5% by volume of argon and had a mass flow of 2 kg/s.

Gas mixture produced from stream A and stream B in example 1 and comparative example 2: The gas mixture had an oxygen content of 6% by volume, which is thus below the theoretical ignition threshold of 8% by volume oxygen in ethylene-oxygen mixtures.

However, in the course of the mixing process of stream A with stream B, starting from the oxygen content of 99.5% by volume in stream B, the ignitable range with local oxygen concentrations of from 99.5% by volume to 8% by volume (ignition threshold) was entered. The energy input necessary for igniting such gas mixtures is between 0.001 and 0.07 mJ, depending on the oxygen content of the ethylene-oxygen mixture. In the mass flows of streams A and B, this ignition energy can be released merely by a particle weighing μg colliding with the pipe wall.

### EXAMPLE 1

The following mixing device was used:

The mixing device comprised a DN500 pipe as the main pipe 1, into which were inserted seven plates 2 arranged parallel to one another and welded to opposite pipe walls of the main pipe 1. The flat sides 3 of the plates 2 were here oriented parallel to the longitudinal direction of the main pipe 1.

Branching off from the distributor pipe 4 outside the main pipe 1 were seven supply lines 4a. Each supply line 4a passed into and through a plate 2. In the plate 2, channels 5 branched off perpendicularly from each supply line 4a.

Starting from the distributor pipe 4 via feed lines 4a and channels 5, gas could be introduced into the main pipe 1 through the outlet openings 6.

The outlet openings 6 were installed at the end face of the plates 2 facing away from the gas flow when the hydrocarbon-containing stream A flows through the main pipe 1.

In this mixing device, the hydrocarbon-containing stream A was conveyed through the main pipe 1.

The oxygen-containing stream B was introduced into the distributor pipe 4 and mixed with the hydrocarbon-containing stream A on exiting the outlet openings 6.

The end faces of the plates 2 onto which were flowing the hydrocarbon-containing stream A in the main pipe 1 were rounded.

The end faces of the plates 2 facing away from the flow direction of the hydrocarbon-containing stream A in the main pipe 1 were flat.

The ignitable volume in example 1 was smaller than 20 liters and extended over a length of less than 30 cm. Within this region, a homogeneous gas mixture formed.

The pressure increase in the event of a possible ignition in such a system is <0.5 bar.

The mixing length was thus short and the mixing volume small, so mixing occurred efficiently.

The device according to the invention ensured that no ignitable mixture formed in the region of the pipe wall and on the internals, particularly in the region of the pipe wall of main pipe 1. In addition, the device according to the invention ensured that the streams A and B or the mixture thereof flowed in the same direction through the main pipe 1 and that particles carried along did not collide with the pipe wall or internals within the ignitable mixing zone and thus that no ignition energy was released within the ignitable mixing zone.

### Comparative Example 2

The mixing device comprised a DN500 pipe as main pipe 1, into which was inserted a conventional nozzle with a radial oxygen supply line.

The hydrocarbon-containing stream A was conveyed through the main pipe 1.

The nozzle had small holes distributed over the circumference of the main pipe 1, through which the oxygen-containing stream B was introduced into the hydrocarbon-containing stream A in the main pipe 1.

In comparative example 2, the ignitable volume was 65 liters and extended over a length of 2 meters.

The pressure increase in the event of ignition was over 1.5 bar.

Disadvantageously, ignitable volume formed at the edge of the main pipe 1. Because the gas was flowing along the main pipe 1, this means that, if particles are being carried along in the flow, a particle collision can occur in this region with the release of ignition energy, thereby igniting the ignitable volume.

1-14. (canceled)

15. A device made of stainless steel for mixing gases, comprising:
a main pipe into which are inserted a plurality of plates arranged parallel to one another, wherein the plurality of plates extend from one pipe wall to the opposite pipe wall of the main pipe and oriented with their flat sides parallel to the longitudinal direction of the main pipe;
a distributor pipe from which a plurality of supply lines branch off outside the main pipe;
wherein each supply line leads into a separate plate of the plurality of plates and is connected in the plurality of plates to a plurality of channels that are connected via outlet openings to the main pipe;
wherein the outlet openings are installed at the end faces of the plurality of plates facing away from the gas flow when a gas flows through the main pipe; and
wherein the end faces of the plurality of plates facing away from the gas flow when a gas flows through the main pipe are flat.

16. The device of claim 15, wherein end faces of the plurality of plates facing the gas flow when a gas flows through the main pipe are rounded.

17. The device of claim 15, wherein at least four of the plurality of plates are inserted into the main pipe.

18. The device of claim 15, wherein in a cross section through the main pipe and the plurality of plates, the total cross-sectional area of all the plurality of plates is 20% to 60% of the cross-sectional area of the main pipe.

19. The device of claim 15, wherein the distance between two adjacent plates of the plurality of plates is 5 cm to 15 cm.

20. The device of claim 15, wherein all of the outlet openings of all of the plurality of plates are in a plane perpendicular to the cross section of the main pipe.

21. The device of claim 15, wherein the outlet openings have a diameter of 1 mm to 5 mm and/or
wherein the plurality of channels have a diameter of 1 mm to 5 mm.

22. The device of claim 15, wherein there are at least 100 outlet openings per 1 m² cross-sectional area of the main pipe.

23. The device of claim 15, wherein the outlet openings are uniformly distributed over the entire cross section of the main pipe; and
wherein the distances of the outlet openings from the inner wall of the main pipe are greater than the distance between two adjacent outlet openings of a plate of the plurality of plates.

24. The device of claim 15, wherein the outlet opening of a plate of the plurality of plates that is closest to the inner wall of the main pipe is a distance from the inner wall of the main pipe that is 3% to 15% of the diameter of the main pipe.

25. The device of claim 15, wherein the total cross-sectional area of all of the plurality of channels is less than 60% of the cross-sectional area of the supply line; and/or
wherein the total cross-sectional area of all supply lines is less than 66% of the cross-sectional area of the distributor pipe.

26. A method for mixing gases, comprising:
providing a device made of stainless steel for mixing gases, wherein the device comprises a main pipe into which are inserted a plurality of plates arranged parallel to one another, wherein the plurality of plates extend from one pipe wall to the opposite pipe wall of the main pipe and oriented with their flat sides parallel to the longitudinal direction of the main pipe, a distributor pipe from which a plurality of supply lines branch off outside the main pipe, wherein each supply line leads into a separate plate of the plurality of plates and is connected in the plurality of plates to a plurality of channels that are connected via outlet openings to the main pipe, wherein the outlet openings are installed at the end faces of the plurality of plates facing away from the gas flow when a gas flows through the main pipe, and wherein the end faces of the plurality of plates facing away from the gas flow when a gas flows through the main pipe are flat;
passing a first gas through the main pipe; and
introducing a second gas into the distributor pipe and conveying the second gas via the supply lines and the plurality of channels through the plurality of plates and flows into the main pipe via a plurality of outlet openings.

27. The method of claim 26, wherein the velocity of the second gas on exiting the outlet openings is greater than the velocity of the first gas in the segment of the main pipeline in which the plurality of plates are located.

28. The method of claim 26, wherein the first gas contains ≥50% by volume, based on the total volume of the first gas, of one or more hydrocarbons; and/or
wherein the second gas contains ≥20% by volume, based on the total volume of the second gas, of oxygen.
